(19) United States
(12) Patent Application Publication
(10) Pub. No.: US 2016/0004685 A1
(43) Pub. Date: Jan. 7, 2016

(54) Insurance Data Archiving and Retrieval System

(71) Applicant: IGATE Global Solutions Ltd., Navi Mumbai (IN)

(72) Inventor: Vaibhav P. Tawade, Navi Mumbai (IN)

(21) Appl. No.: 14/716,232

(22) Filed: May 19, 2015

Related U.S. Application Data
(60) Provisional application No. 62/020,116, filed on Jul. 2, 2014.

(51) Int. Cl. G06F 17/24; G06F 17/21; G06F 17/30

(52) U.S. Cl. CPC G06F 17/248; G06F 17/30371; G06F 17/212; G06F 17/243

(57) ABSTRACT

A method and apparatus for retrieving and presenting insurance data from a legacy insurance data archiving system receives insurance data originating from legacy data storage of the legacy insurance data archiving system. The legacy insurance archiving system has an associated legacy format for formatting the insurance data for display on a display device. The legacy format also includes at least a screen format for displaying the insurance data on the display device. The method and apparatus also store the received insurance data in a database on memory of a second insurance data archiving system, and generates a display screen template substantially having the screen format of the legacy insurance archiving system. The display screen template has fields that each are configured to display at least one datum of the received insurance data. The method and apparatus also stores the display screen template in the memory of the second system.

### PRIORITY

This patent application claims priority from Provisional U.S. patent application No. 62/020,116, filed Jul. 2, 2014, entitled, “METHOD AND APPARATUS FOR ARCHIVING LEGACY INSURANCE POLICY AND CLAIMS DATA,” and naming Vaibhav P. Tawade as inventor, the disclosure of which is incorporated herein, in its entirety, by reference.

### FIELD OF THE INVENTION

The invention generally relates to insurance data management and, more particularly, the invention relates to archiving legacy insurance data for subsequent retrieval.

### BACKGROUND OF THE INVENTION

Insurance companies typically store a wide variety of insurance information/data in standard proprietary formats. Among other things, this insurance data may include:
details of the insurance policy, such as coverage information, rider information, and benefit information,
personal information about the insured party,
personal information about the beneficiaries of the insurance policy,
history of claims made against insurance policy or by an insured party, and
related policies for an insured party.

As with the vast majority of data in the business world, high-capacity data archiving systems/platforms commonly manage, secure, and store insurance data. For example, many insurance companies use application systems implementing the well-known Consumer Information Control System (“CICS”), distributed by IBM, and Virtual Storage Access Method (VSAM), distributed by Computer Associates, to store and manage insurance data. These widely used platforms incorporate certain formats and procedures that are well known to those in the insurance industry. In other words, many people in the insurance industry are familiar with their interface, which facilitates business processing using business functions provided by these systems.

Although widely used systems have proven to be beneficial for many years, they often are decommissioned in view of new platforms and thus, become “legacy systems.” The number of people having the appropriate skillsets required to manage them thus continues to shrink. Insurance companies thus migrate to new insurance data archiving platforms—some of which have different requirements and standard processes. For example, a new platform may store the insurance data in a different format, and/or display the data in a different format.

These different formats and requirements can make transitioning to a new insurance data management architecture complicated and expensive. Accordingly, those in the art typically convert only active policies and a small number of terminated policies to the new system—typically two to seven years of terminated policies are converted to the new system.

The remaining terminated insurance policy data, which can span back over 30-40 years and have millions of data sets, often are stored on backup tapes for retrieval on an ad-hoc basis. Undesirably, retrieval from these backup tapes generally is complicated and requires 1) specialized knowledge of the old format and 2) ad-hoc programming by IT professionals. For example, IT professionals often write new scripts or programs to interface with the backup data. Access to the backup data therefore is inefficient and time-consuming, consequently increasing the cost of researching this data for an unplanned query.

### SUMMARY OF VARIOUS EMBODIMENTS

In accordance with one embodiment of the invention, a method of retrieving and presenting insurance data from a legacy insurance data archiving system receives insurance data originating from legacy data storage of the legacy insurance data archiving system. The legacy insurance archiving system has an associated legacy format for formatting the insurance data for display on a display device. The legacy format also includes at least a screen format for displaying the insurance data on the display device. The method also stores the received insurance data (in a prescribed format) in a database on memory of a second insurance data archiving system for subsequent retrieval, and generates a display screen template substantially having the screen format of the legacy insurance archiving system. The display screen template has a plurality of fields that each are configured to display at least one datum of the received insurance data. The method also stores the display screen template in the memory of the second insurance data archiving system for subsequent retrieval.

For retrieval, the method receives a request from a requestor to access at least one datum of the received insurance data and then, in response to receipt of the request, retrieves the stored display screen template. Next, the method accesses the database, with a processor, to retrieve the at least one datum based on the fields of the template to produce at least one retrieved datum, populates the fields of the retrieved display screen template with the at least one retrieved datum to produce a populated display screen template having the screen format of the legacy insurance archiving system, and forwards the populated display screen template for display on a display device.

To produce the prescribed format, the method may transform the received insurance data into a second system format to produce transformed insurance data. In that case, the transformed insurance data is compatible with the second system and the display screen template and thus, acts as the prescribed format. For example, the transformed insurance data may be in ASCII format. In other embodiments, the prescribed format is the native format of the received data—i.e., the format in which it was received.

Some embodiments may display a user interface having a request field for requesting insurance data from the second system, and enter information into the request field. Next, the method may access the database to retrieve by accessing an index of the stored insurance data based on the information in the request field, and display, on a display device, the insurance data by using the populated display screen template. In some embodiments, a browser displays the user interface.

Among other types, the screen format of the legacy insurance archiving system includes a 24×80 format. Moreover, the insurance data may include insurance policy and claims data. In some implementations, the insurance data includes meta-data.

Some embodiments form a plurality of display screen templates that each have substantially the screen format of the legacy insurance archiving system. Each display screen template thus has a plurality of fields configured to display at least one datum of the received insurance data, and the screen template being populated may be one of the plurality of display screen templates. The method thus may retrieve by selecting the given screen template as a function of information in the request.

In accordance with another embodiment, an insurance data archiving and retrieval system for retrieving and presenting insurance data from a legacy insurance data archiving system has an for receiving insurance data originating from legacy data storage of the legacy insurance data archiving system. The legacy insurance archiving system has an associated legacy format for formatting the insurance data for display on a display device, and the legacy format has at least a screen format for displaying the insurance data on the display device. The system also has a configurator, operatively coupled with the input, configured to generate a display screen template substantially having the screen format of the legacy insurance archiving system. The display screen template has a plurality of fields that each are configured to display at least one datum of the received insurance data. The system further has memory, operatively coupled with the configurator, configured to store the received insurance data in a database. The memory also is configured to store the display screen template.

In addition to the input, configurator and memory, the system also has an executor, operatively coupled with the configurator, configured to retrieve, in response to receipt of a request to access at least one datum of the received insurance data, the stored display screen template. The executor also is configured to access the database to retrieve the at least one datum based on the fields of the template, and populate the fields of the retrieved display screen template with the at least one retrieved datum to produce a populated display screen template having the screen format of the legacy insurance archiving system. To forward data, the system has an output operably coupled with the executor and configured to forward the populated display screen template for display on a display device.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a legacy insurance data conversion and access system configured in accordance with illustrative embodiments of the invention.

FIG. 2 shows a process of converting and preserving legacy insurance data in accordance with illustrative embodiments of the invention.

FIG. 3 schematically shows a user interface for selecting a particular database of information for conversion.

FIG. 4 schematically shows a user interface about to be configured for particular purpose.

FIG. 5 schematically shows the fields that can be selected for the user interface of FIG. 4.

FIG. 6 schematically shows the user interface of FIG. 4 with all of its fields completed.

FIG. 7 schematically shows a user interface and exemplary fields for indexing the user interface of FIG. 4.

FIG. 8 schematically shows the user interface of FIG. 7 with its fields completed.

FIG. 9 shows a process of accessing legacy insurance data in accordance with illustrative embodiments of the invention.

FIG. 10 schematically shows a user interface for retrieving legacy insurance data and accordance with one embodiment of the invention.

FIG. 11 schematically shows the user interface of FIG. 10 with user request data in the user input fields.

FIG. 12 schematically shows the user interface of FIG. 10 with a retrieved insurance record.

FIG. 13 shows a process of accessing legacy insurance data in accordance with other embodiments of the invention.

### DESCRIPTION OF ILLUSTRATIVE EMBODIMENTS

In illustrative embodiments, an insurance data archiving and retrieval facility converts and maintains legacy insurance data for easy access at a later date. No specialized scripts, programming skills, or in-depth technical knowledge thus is required to access this legacy insurance data. Instead, all that is needed is a simple interface, such as a web browser, to access the data.

To that end, the facility converts the legacy insurance data into a format that is easily accessible by a wide variety of software products. For example, as noted above, the insurance data may be stored in a format that a web browser can easily access and display. In fact, some embodiments use graphical user interfaces (for retrieving and displaying the legacy insurance data) that are formatted substantially the same way as the legacy display format. Accordingly, users of the legacy system can use familiar processes to access and use the legacy insurance data.

Such embodiments thus provide a substantial technical advance—i.e., rather than require specialized technical efforts and a significant amount of time to obtain old/legacy insurance information, this facility provides access to virtually any prescribed insurance information originally on the legacy system regardless of the age of that information. Accordingly, in solving a problem specifically arising in the realm of data archiving systems, this illustrative system provides a specific technical solution that enables unskilled people to easily access legacy insurance information. Details of illustrative embodiments are discussed below.

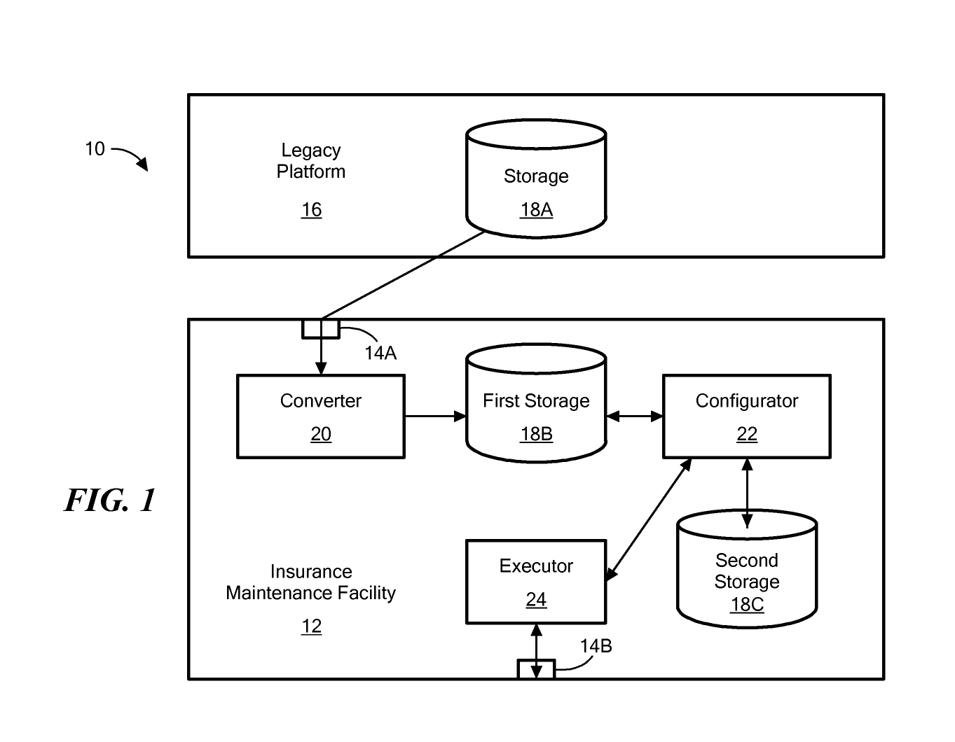

FIG. 1 schematically shows an insurance data archiving system for maintaining legacy insurance data. Each of these components is operatively connected by any conventional interconnect mechanism. FIG. 1 simply shows direct lines communicating each the components. Those skilled in the art should understand that this generalized representation can be modified to include other conventional direct or indirect connections. Accordingly, discussion of any specific interconnection is not intended to limit various embodiments.

Indeed, it should be noted that FIG. 1 only schematically shows each of these components. Those skilled in the art should understand that each of these components can be implemented in a variety of conventional manners, such as by using hardware, software, or a combination of hardware and software, across one or more other functional components. For example, the configurator 22 (discussed below) may be implemented using a plurality of microprocessors executing firmware. As another example, the configurator 22 may be implemented using one or more application specific integrated circuits (i.e., “ASICs”) and related software, or a combination of ASICs, discrete electronic components (e.g., transistors), and microprocessors. Accordingly, the representation of the configurator 22 and other components in a single box of FIG. 1 is for simplicity purposes only. In fact, in some embodiments, some of the components of FIG. 1 may be distributed across a plurality of different machines—not necessarily within the same housing or chassis.

It should be reiterated that the representation of FIG. 1 is a significantly simplified representation of an insurance data archiving system. Those skilled in the art should understand that such a system has many other physical and functional components. Accordingly, this discussion is in no way intended to suggest that FIG. 1 represents all of the elements of a system 10.

The system 10 of FIG. 1 may be considered to include a legacy platform 16 having a storage device 18A that stores legacy information in its native format, and a conversion and retrieval facility (“facility 12”) that converts and stores legacy insurance data (on the legacy platform 16) for subsequent retrieval. The facility 12 also includes functionality for easily interacting with people requesting the information (a “requestor”), and forwarding or displaying that information to that requester.

To those ends, the facility 12 has a first interface 14A for communicating with the legacy insurance platform 16 or a device having the insurance data that at one time was resident on the legacy insurance platform 16 (i.e., the insurance data may be considered to originate from the legacy insurance platform 16). To simplify this description, the term “legacy insurance platform 16” generally refers to both the platform 16 itself and/or simply a device having the legacy insurance data. Among other things, the first interface 14A may receive stored legacy insurance data from long term storage 18A of the legacy insurance platform 16.

As noted, the legacy insurance data may originate from the legacy insurance platform 16, which is being retired or phased out in favor of a new insurance management platform. Alternatively, the legacy insurance platform 16 simply may be in the process of being upgraded to a new version. As such, the legacy platform 16 may include insurance data dating back many decades. Rather than converting only a small fraction of the legacy insurance data, illustrative embodiments convert most or all of the legacy insurance data into a format that is easy to retrieve.

The facility 12 thus also has an optional converter 20 for transforming/converting the incoming legacy insurance data into a prescribed format for use by the remaining portions of the facility 12. This transformed information is stored in a first storage device 18B for subsequent retrieval when requested. Some embodiments, however, omit the converter 20 and simply store the data from the legacy platform 16 generally in the form it is received. Still some embodiments may implement the converter 20 on another platform, such as on the legacy platform 16. In that case, the converter 20 would forward the converted information to the first storage 18B on the facility 12 via the first interface 14A.

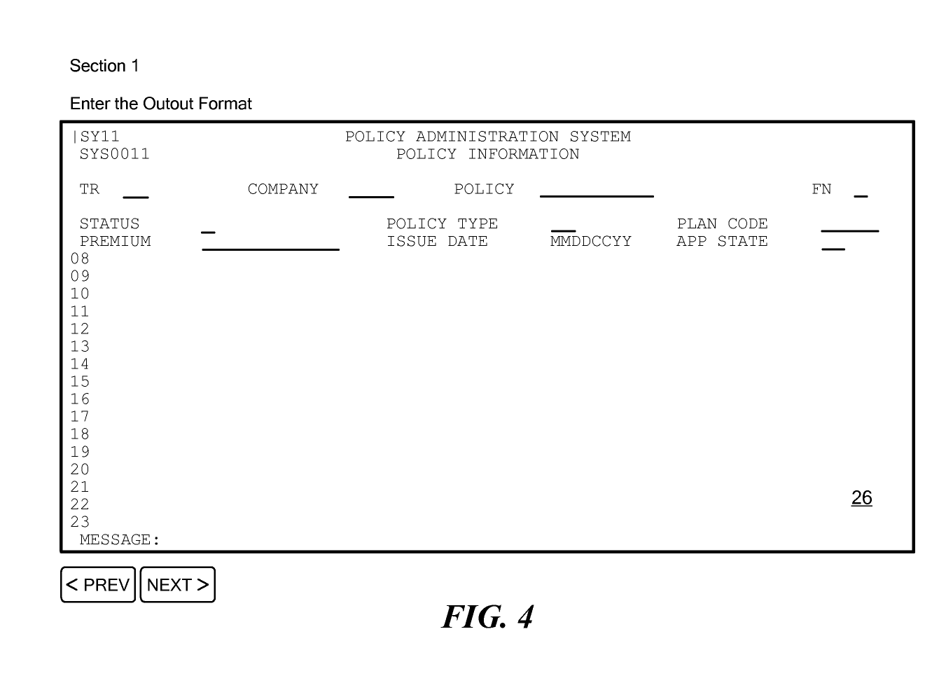

In addition, the facility 12 also has a configurator 22 that, among other things, generates and populates display screen templates 26 (see, for example, FIG. 4, discussed below) for displaying the converted insurance data. As noted above, those screen templates 26 preferably have the same format as, or substantially the same as the format as, the legacy platform 16. In alternative embodiments, however, the screen format may substantially differ from the format used by the legacy platform 16. Each of the screen templates 26 is stored in a second storage device 18C, which may be part of the first storage device 18B or an independent storage device.

The facility 12 also has a second interface 14B, which may be separate or part of the first interface 14A, for interacting with external systems. Among other things, the second interface 14B may communicate with a remote computer system (e.g., across the Internet or across a LAN or WAN) requesting legacy insurance information/data. For example, an insurance adjuster on a remote computer system may request legacy insurance data from some device. If not directed to the facility 12, then the request is intercepted by the facility 12, which, in either case, acts on it to produce the requested information. Accordingly, that insurance adjuster forwards an information request to the facility 12.

The facility 12 thus has an executor 24 that receives and acts on external requests received via the second interface 14B. For example, as discussed in greater detail below, in response to a request from an insurance adjuster or other requestor, the executor 24 may request that information from the configurator 22. As discussed in detail below, in response to this request, the configurator 22 retrieves the appropriate screen template 26 from the second storage 18C, populates the retrieved screen template 26 with converted data from the first storage 18B, and delivers it to the executor 24. The executor 24 then may forward that information to the requester in any of a number of manners.

It should be noted that the facility 12 is illustrative of one way of implementing various embodiments. Accordingly, those skilled in the art may implement various embodiments in any of a number of different manners. For example, the storage devices 18B and 18C may be cloud storage or otherwise widely distributed storage. FIG. 1 therefore is but a single example, and not intended to limit various embodiments of the invention.

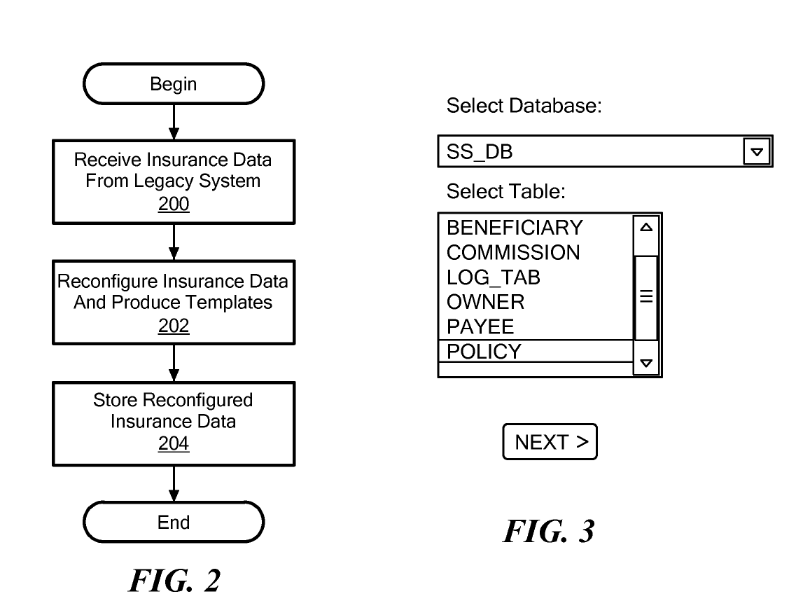

FIG. 2 shows a process for converting and preserving legacy insurance data in accordance with illustrative embodiments of the invention. It should be noted that the process of FIG. 2 is a simplified version of a longer process. Accordingly, those skilled in the art should understand that the process may use additional steps not specifically discussed, or use more sub-steps during execution of the individual steps. Moreover, although this process is described as being executed by the facility 12 of FIG. 1, those skilled in the art should understand that systems having similar functionality also may perform this process.

The process begins at step 200 in which the facility 12 receives legacy insurance data via its first interface 14A from the legacy insurance platform 16. After receipt, the converter 20 begins reconfiguring insurance data into a prescribed format that may be easily retrieved and used to populate prescribed screens (step 202). For example, the converter 20 may transform the data into ASCII format for storage in a legacy insurance database in the first storage device 18B. In alternative embodiments, the converter 20 may maintain the received insurance data in its original format. The converter 20, which may be manually operated by a technician or use an automated process, therefore should have the requisite intelligence and knowledge to read the incoming insurance data and convert the legacy insurance data into the appropriate format.

Some of the legacy insurance data, however, may not directly convert to the new format (e.g., ASCII). For example, some of that data may have special field formats, which, for example, could cause certain data to be invisible to the user, or not be necessary for display to the user. Accordingly, the configurator 22 (or the converter 20) resolves such complex data and, as noted, stores such converted data in the insurance data database of the first storage device 18B.

In addition to reconfiguring the legacy insurance data, as noted above, the configurator 22 also generates screen templates 26 (e.g., see FIG. 4) for displaying requested legacy information. As noted above, the facility 12 preferably permits access to and display of the insurance data in a format that is substantially the same as the legacy format. For example, as discussed in greater detail below, the configurator 22 may configure the screen format into the widely used 24×80 screen format used by the Consumer Information Control System (“CICS,” an application server and connector that provides online transaction management for the insurance industry), distributed by International Business Machines of Armonk, N.Y. The configurator 22 thus should have the knowledge of the screen format of the legacy platform screen format to form the template 26.

The configurator 22 stores the converted insurance data and screen template(s) 26 in the second storage device 18C (e.g., in another insurance database) for subsequent retrieval (step 704). In other words, in this embodiment, the configurator 22 stores the converted data of storage device 18B in storage device 18C. Other embodiments, however, may keep the converted data in storage device 18B. Indeed, although generically noted as being stored on the same storage device 18C, the insurance data and screen template(s) 26 illustratively are stored separately and for potential subsequent use together (discussed below). This process continues until all relevant insurance data, including the screen templates 26, are respectively converted and stored in the storage devices 18B and 18C.

In some embodiments, the configurator 22 has the necessary independent user interfaces for performing much of this process. In other embodiments, however, the executor 24 interfaces with the configurator 22 to control much of its processing. Examples follow below.

FIGS. 3-8 schematically show a plurality of graphical user interfaces and template 26 used for one illustrative implementation of the process of FIG. 2; namely, those figures exemplify a process executed by the configurator 22 for generating properly formatted screen templates 26 for displaying the insurance data. In this case, a technician or other user operates the configurator 22 and interacts with these graphical user interfaces. The progression of these figures generally follows that of FIG. 2. The configurator of this implementation thus is pre-programmed with information about the legacy templates, but enables the user to refine them further.

In some embodiments, insurance information is stored in different databases/sub-databases of those noted above. Specifically, FIG. 3 shows an initial stage in the process in which a user selects a particular database and type of insurance document to retrieve. To that end, the user selects a database from a drop-down menu—in this example, the user selected the database “SS_DB.” In addition, the type of insurance document to retrieve (which controls the template 26 to use) can be selected from any of a number of different options, such as “beneficiary information,” “commission table,” a “log table,” “owner information,” “payee information,” “policy information,” etc.

After selecting the “Next” button, the configurator 22 then displays the graphical user interface of FIG. 4 to the user. This interface more specifically is the type of screen template 26 the configurator 22 has stored for the selected type of table and database. Again, this screen template 26 was stored based on knowledge of the legacy format. Some embodiments, however, may require the user to manually enter this screen template information. For example, such embodiments may require the user to create the template.

As shown, this exemplary graphical user interface is a 24×80 CICS screen, which is substantially similar to many widely used legacy insurance platforms 16. Accordingly, in this example, the screen/template 26 has up to 24 rows and 80 columns of characters. This permits the display of any of a number of fields, which, in this case, includes “COMPANY,” “STATUS PREMIUM,” “POLICY,” “PLAN CODE,” “ISSUE DATE,” etc.

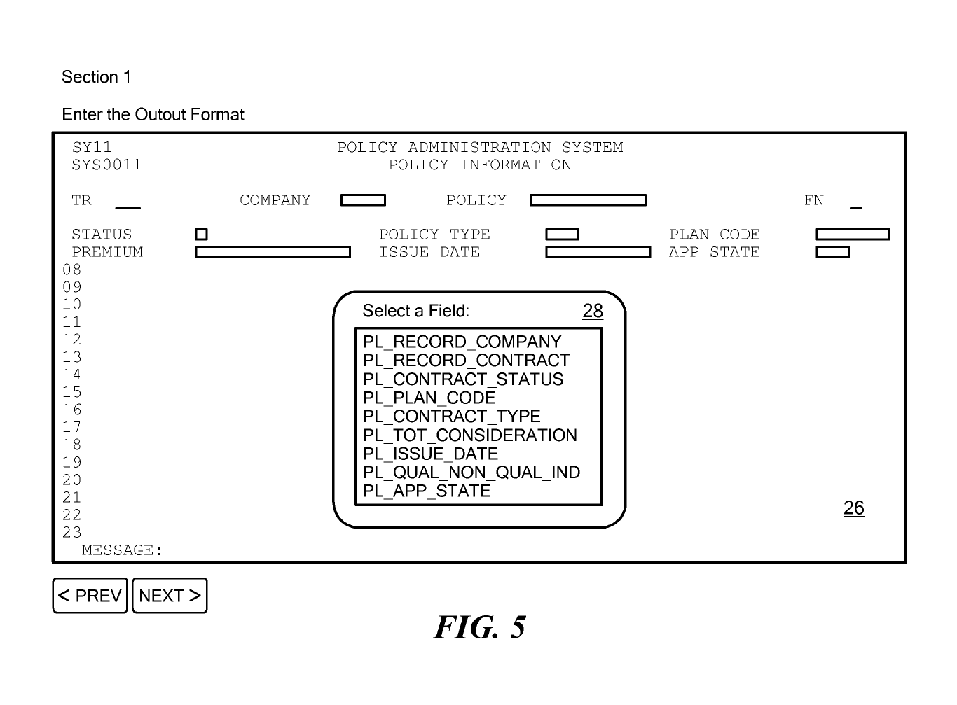

After setting up the screen template format of FIG. 4, the user selects the “Next” button to begin entering the correct fields into the form/screen. To that end, as shown in FIG. 5, the user selects a box next to one of the fields in the form, and then double-clicks on one of the selectable fields in a field list 28. For example, the field list 28 of this example has nine different choices. Again, these field choices may be prescribed, as by using the field list 28 that was derived from prior knowledge about the legacy format, or manually entered with a user simply entering fields into the appropriate boxes. These fields correspond to fields in the database(s) in the first storage device 18B and, as noted below, act as variables for retrieving the appropriate information from the insurance database(s).

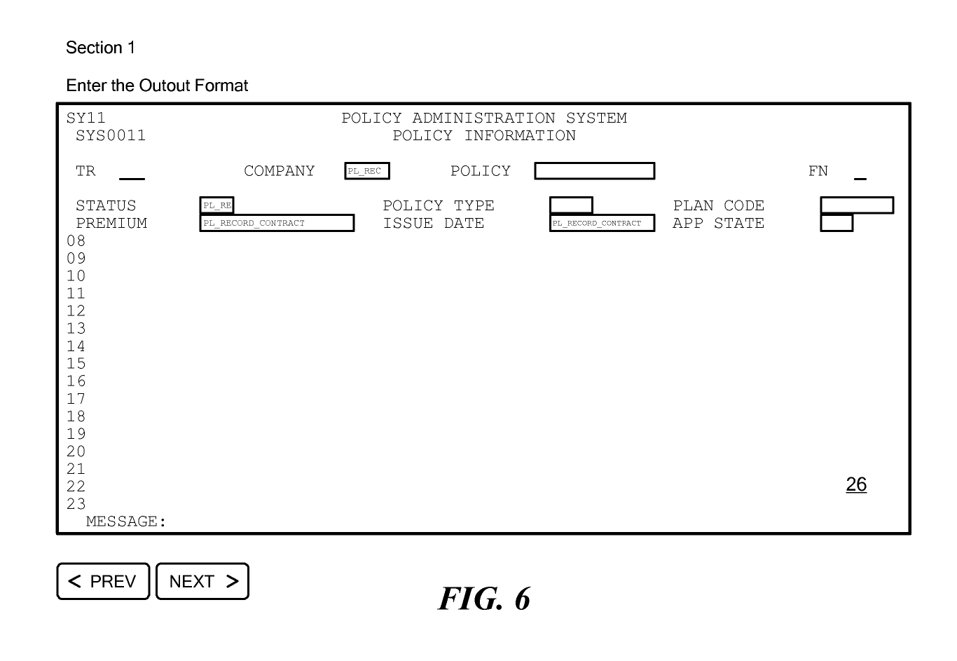

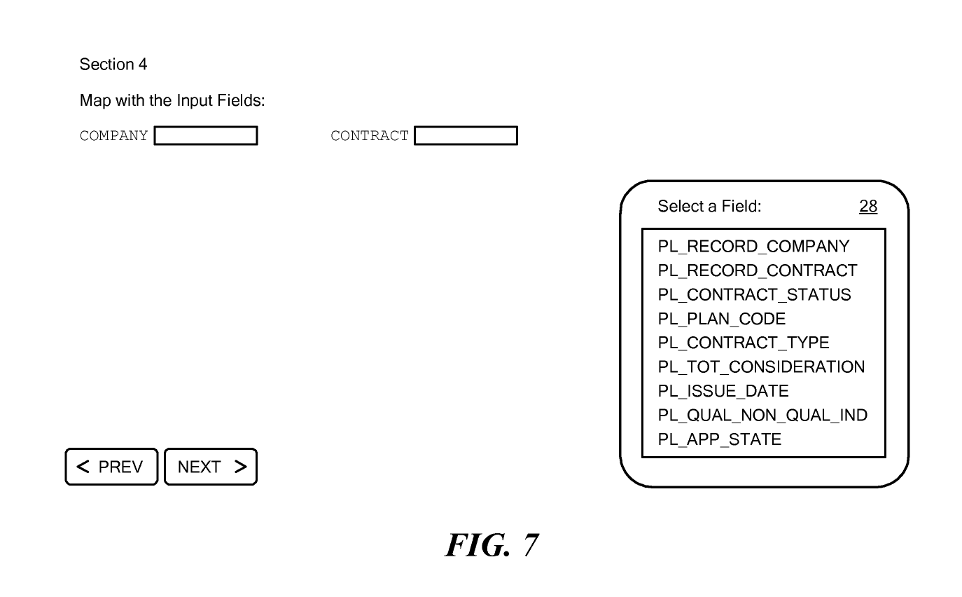

FIG. 6 shows this form/template 26 after the user has entered the fields for each box. For example, next to the “POLICY” field, the user/configurator 22 entered the field “PL_RECORD_CONTRACT.” Accordingly, when this form is populated with actual insurance data, the data of the record from that indexed field (i.e., the “PL_RECORD_CONTRACT” field) will be positioned in that box. This process continues until the configurator 22 generates the properly formatted screen template 26. Next, the configurator 22 must identify each screen template 26—i.e., provide a mechanism for retrieving the newly created screen template 26, which will be used to display pre-specified insurance data. To that end, FIG. 7 shows a graphical user interface displayed after the configurator 22 completes the fields of FIG. 6. In alternative embodiments, however, the user may simply provide a name for the newly generated template.

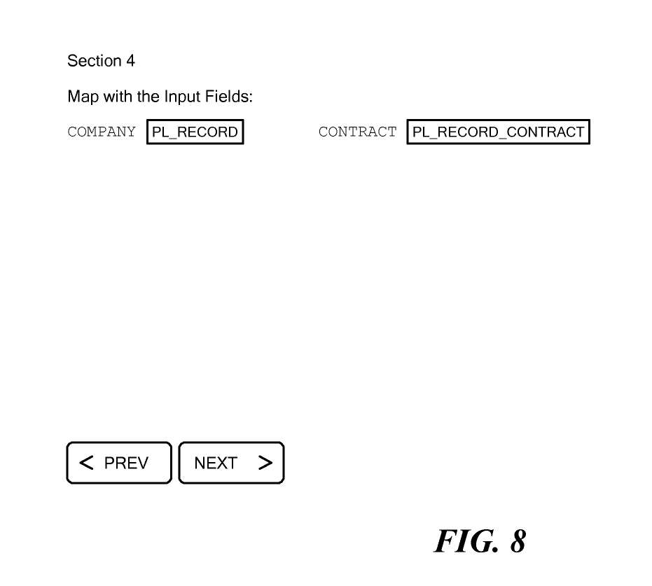

This form/interface has two primary input fields; namely, “COMPANY,” and “CONTRACT.” In a manner similar to the steps shown in FIGS. 5 and 6, the user/configurator 22 chooses one of a plurality of selectable fields in this field listing 28 to enter into the boxes next to the input fields. FIG. 8 schematically shows the next step, and which both input fields are specified. To conclude this phase, the user selects the “Next” button, which causes all the prescribed screen templates 26 to be stored in one or both of the stores devices 18B and 18C.

Now that the configurator 22 has produced the requisite template(s) 26, a person can relatively easily access the legacy insurance data through the executor 24. No specialized programming or detailed technological knowledge of the legacy system is required. Instead, in illustrative embodiments, a minimum degree of skill is all that is needed to retrieve the insurance information.

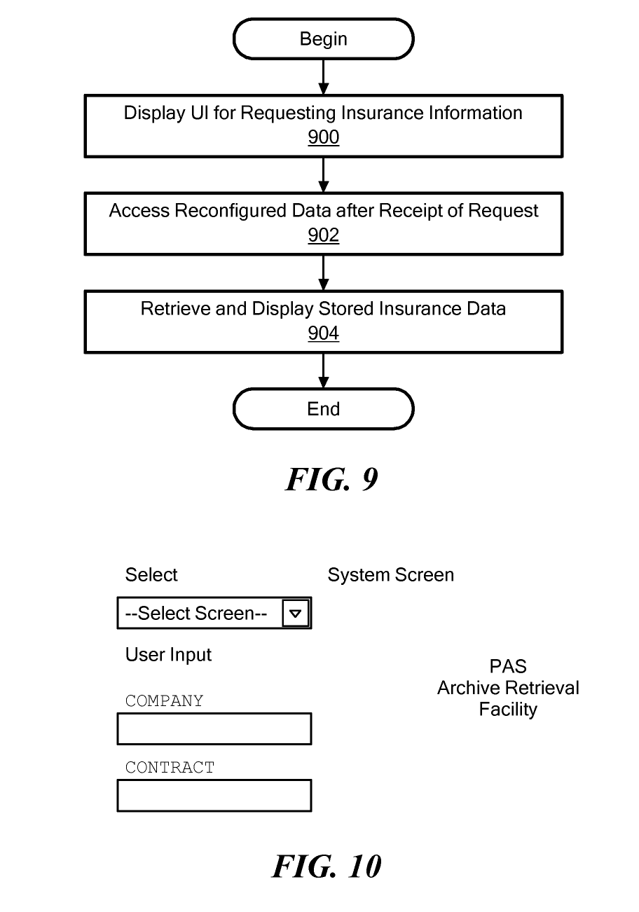

FIG. 9 shows a process for retrieving legacy insurance data in accordance with one embodiment of the invention. As with the process of FIG. 2, the process of FIG. 9 is a simplified version of a longer process. Accordingly, those skilled in the art should understand that the process may use additional steps not specifically discussed, or use more sub-steps during execution of the individual steps. Moreover, although this process is described as being executed by the facility 12 of FIG. 1, those skilled in the art should understand that systems having similar functionality also may perform this process.

After receiving a request from a user (“Requestor”), the executor 24 displays a graphical user interface for requesting insurance data. This graphical user interface may be displayed on a local terminal coupled with the facility 12, or on a remote computer system connected to the Internet. For example, the facility 12 may be maintained at one or multiple locations and accessed from a computer system connected to the Internet (e.g., using a cloud computing technologies or a software-as-a-service model, i.e., a “SAAS model”). Of course, it is expected that many such systems, which have confidential and proprietary insurance data, require virtual private network, encryption, password protection and/or other measures to safeguard the insurance data. As another example, the Requestor may be operating on a local device within a local area network (LAN) within an enterprise system.

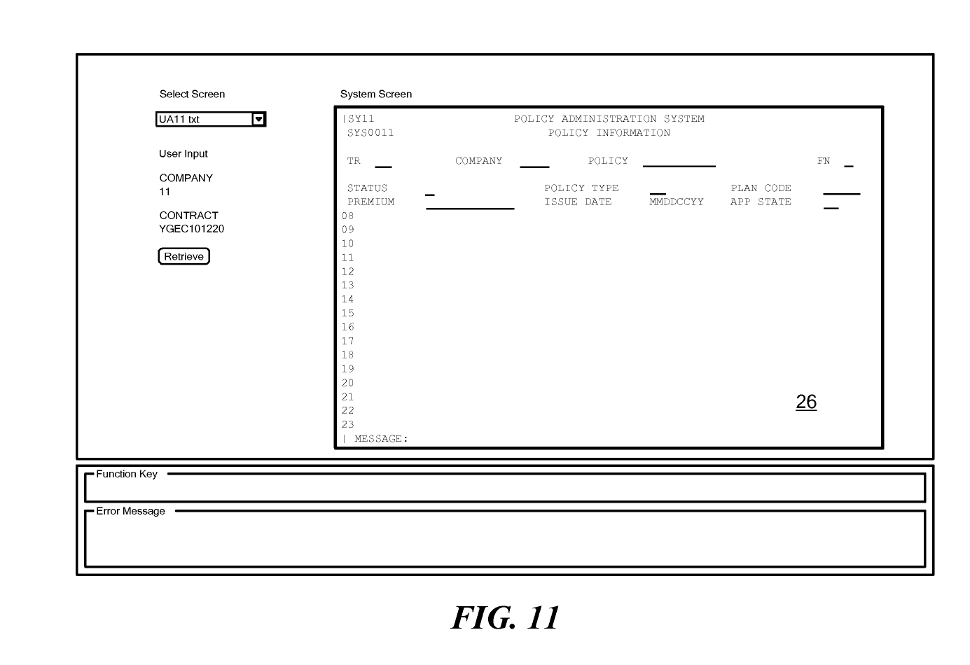

FIGS. 10 and 11 schematically show an example of one such graphical user interface for retrieving legacy insurance information. Specifically, the first screen (FIG. 10) shows the name of the archive retrieval facility 12, and requests user input similar to that shown in FIGS. 7 and 8; namely, a screen to select, “COMPANY,” AND “CONTRACT.” The user then selects an appropriate screen template 26 (“UA11txt” in this example), which produces the appropriate template, and enters both a company number and contract number in the appropriate boxes (FIG. 11). To that end, the configurator 22 accesses the database to determine the appropriate form based on the user selection. Indeed, the specific company and contract numbers, as well as the screen identification, should be readily available to the requester. Some embodiments may have a look up functions that enables the requester to retrieve this information from a database. Other embodiments may have a natural language interpreter that can access the appropriate information.

The requester may request the insurance data via a graphical user interface using any of a wide variety of conventional software products. For example, the requester may simply use a web browser, such as Internet Explorer (Microsoft Corporation) or Google Chrome (Google Inc.). Alternative embodiments, however, may use a customized software product to obtain such access.

After entering the data, the requestor views or selects the “Retrieve” button, which causes the executor 24 to access the information and appropriate template 26 from the second storage device 18C (step 902). Some embodiments may direct the inquiry from the executor 24 to the configurator 22, which accesses the information and appropriate template 26 from the second storage device 18C. The executor 24 or the configurator 22, as the case may be, then accesses the appropriate database to retrieve the appropriate insurance data.

To that end, the appropriate logic accesses the database to retrieve the contract of the selected company. In the example, the logic accesses data for Company 11 and Contract YGEC101220. Then, using the variables/fields of the selected template 26, the logic accesses the database to locate the appropriate insurance information for each field in the template 26. For example, the field “Plan Code” has a variable assigned to it, such as that shown in FIG. 6. The logic thus uses that variable/field to access the database for that specific record. After it locates that particular datum for that field, the logic adds that datum to that appropriate field in the template 26.

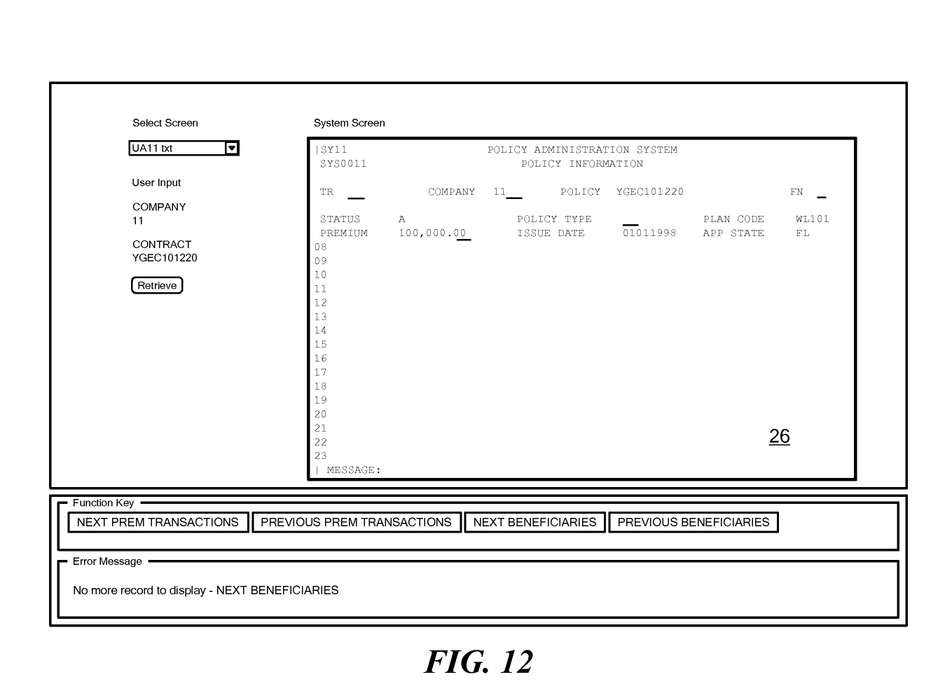

Note that embodiments having the insurance information in a prescribed format that is understandable to the logic should improve processing speed and reduce errors. For example, as noted above, the insurance data may be stored in the database in ASCII format. The logic thus is programmed to understand and manage ASCII data. If the data were a format that was not understandable to the logic, then additional steps may be required to fill the form. The logic thus repeats this process for all required fields of the template 26, thus populating the template 26 with the required insurance data (step 904). FIG. 12 schematically shows one example of such a screen with the requisite populated insurance data.

In particular, among other things, this form shows the premium of the policy as $100,000, the policy number as YGEC101220, the issue date of the policy as Jan. 1, 1998, etc. This screen display is in the legacy format of the legacy system 16 and thus, should be readily understandable to a requester having experience with such formats. Note that in this embodiment, not all fields are completed (e.g., the Policy Type field is not completed). Accordingly, some embodiments may selectively omit some fields, or complete all fields.

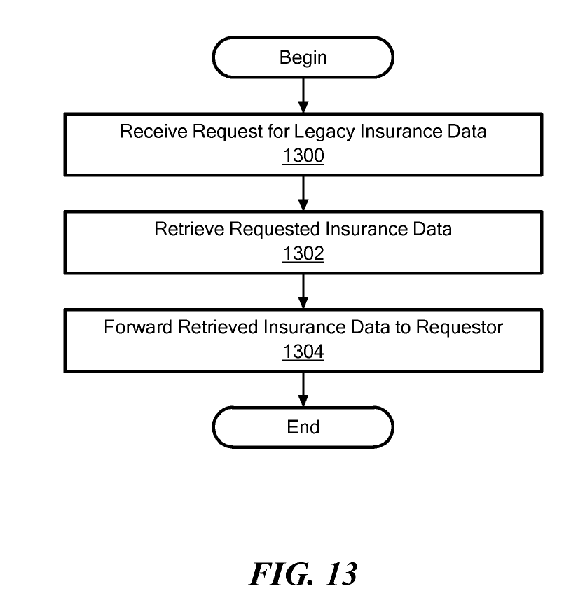

Rather than directly displaying the graphical user interfaces, some embodiments simply receive an electronic request for that information, and forward that information electronically back to requester in a format that may be displayed, as necessary, substantially in the legacy format. FIG. 13 shows one such process, which, like the prior two processes, is a simplified version of a longer process. Accordingly, those skilled in the art should understand that this process may use additional steps not specifically discussed, or use more sub-steps during execution of the individual steps. Moreover, although this process is described as being executed by the facility 12 of FIG. 1, those skilled in the art should understand that systems having similar functionality also may perform this process.

The process begins at step 1300, which receives a request from a requester for legacy insurance data. This may come in the form of an electronic message having the necessary information for locating the insurance data, but not formatted for display on a computer system. Alternatively, this request may come from a requester accessing a user interface, such as the user interface shown in FIG. 11. With or without the configurator 22, the executor 24 responsively retrieves the requested insurance data in a manner similar to that discussed above (step 1302), and forwards the retrieved insurance data to the requester in an electronic message (step 1304). This electronic message may include a link or attachment that, when selected, may display the insurance data in one of the legacy formats as specified by the screen templates 26. In some embodiments, the insurance data is processed after it is received by the requester, but before viewing by the requester. Alternatively, rather than forwarding the retrieved insurance data to the requestor, this step may simply display the retrieved insurance data to the requestor in the appropriate legacy format.

Accordingly, illustrative embodiments provide an efficient and effective mechanism for storing and retrieving legacy insurance data. Such embodiments effectively eliminate the need for specialized knowledge of the legacy platform 16 for the mere purpose of accessing the legacy insurance data. This should save substantial cost and effort, and encourage insurance companies to more readily migrate to updated insurance data management platforms 16.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

Although the above discussion discloses various exemplary embodiments of the invention, it should be apparent that those skilled in the art can make various modifications that will achieve some of the advantages of the invention without departing from the true scope of the invention.

What is claimed is:

1. A method of retrieving and presenting insurance data from a legacy insurance data archiving system, the method comprising:
receiving insurance data originating from legacy data storage of the legacy insurance data archiving system, the legacy insurance archiving system having an associated legacy format for formatting the insurance data for display on a display device, the legacy format including at least a screen format for displaying the insurance data on the display device;
storing the received insurance data in a database on memory of a second insurance data archiving system for subsequent retrieval, the received insurance data being stored in the database in a prescribed format;
generating a display screen template substantially having the screen format of the legacy insurance archiving system, the display screen template having a plurality of fields that each are configured to display at least one datum of the received insurance data;
storing the display screen template in the memory of the second insurance data archiving system for subsequent retrieval;
receiving a request from a requestor to access at least one datum of the received insurance data;
retrieving, in response to receipt of the request, the stored display screen template from the memory in the second insurance data archiving system;
accessing the database, with a processor, to retrieve the at least one datum based on the fields of the display screen template to produce at least one retrieved datum;
populating the fields of the retrieved display screen template with the at least one retrieved datum to produce a populated display screen template having the screen format of the legacy insurance archiving system; and
forwarding the populated display screen template for display on a display device.

2. The method as defined by claim 1 further comprising:
transforming the received insurance data into a second system format to produce transformed insurance data, the transformed insurance data being compatible with the second system and the display screen template, the second system format being the prescribed format; and
storing the transformed insurance data in the database.

3. The method as defined by claim 2 wherein transforming comprises transforming the received insurance data into ASCII format.

4. The method as defined by claim 1 further comprising:
displaying a user interface having a request field for requesting insurance data from the second system;
entering information into the request field;
accessing the database to retrieve by accessing an index of the stored insurance data based on the information in the request field; and
displaying, on a display device, the insurance data by using the populated display screen template.

5. The method as defined by claim 4 wherein a browser displays the user interface.

6. The method as defined by claim 1 wherein the screen format of the legacy insurance archiving system includes a 24×80 format.

7. The method as defined by claim 1 wherein the insurance data includes insurance policy and claims data.

8. The method as defined by claim 1 wherein the insurance data includes meta-data.

9. The method as defined by claim 1 wherein forming comprises forming a plurality of display screen templates that each have substantially the screen format of the legacy insurance archiving system, each display screen template having a plurality of fields configured to display at least one datum of the received insurance data,
the screen template being populated being one of the plurality of display screen templates,
retrieving further comprising selecting the given screen template as a function of information in the request.

10. An insurance data archiving and retrieval system for retrieving and presenting insurance data from a legacy insurance data archiving system, the apparatus comprising:
an input for receiving insurance data originating from legacy data storage of the legacy insurance data archiving system, the legacy insurance archiving system having an associated legacy format for formatting the insurance data for display on a display device, the legacy format including at least a screen format for displaying the insurance data on the display device;
a configurator operatively coupled with the input, the configurator being configured to generate a display screen template substantially having the screen format of the legacy insurance archiving system, the display screen template having a plurality of fields that each are configured to display at least one datum of the received insurance data;
memory operatively coupled with the configurator, the memory being configured to store the received insurance data in a database, the memory also being configured to store the display screen template;
an executor operatively coupled with the configurator, the executor being configured to retrieve, in response to receipt of a request to access at least one datum of the received insurance data, the stored display screen template, the executor also being configured to access the database to retrieve the at least one datum based on the fields of the display screen template, and populate the fields of the retrieved display screen template with the at least one retrieved datum to produce a populated display screen template having the screen format of the legacy insurance archiving system; and
an output operably coupled with the executor, the output being configured to forward the populated display screen template for display on a display device.

11. The system as defined by claim 10 wherein the configurator is configured to transform the received insurance data into a second system format to produce transformed insurance data, the transformed insurance data being compatible with the display screen template, and store the transformed insurance data in the database.

12. The system as defined by claim 10 wherein the executor is configured to produce a user interface for receiving an insurance data request from the requestor.

13. The system as defined by claim 10 further comprising a display device operatively coupled with the executor, the display device being configured to generate the user interface to receive a request to access the at least one datum of the received insurance data.

14. The system as defined by claim 10 wherein the executor is configured to operate with a browser to receive the request.

15. The system as defined by claim 10 wherein the screen format of the legacy format includes a prescribed type of screen for display.

16. The system as defined by claim 15 wherein the screen format of the legacy format includes a 24×80 format.

17. The system as defined by claim 10 wherein the executor is configured to cause the configurator to retrieve and populate the stored display screen template.

18. The system as defined by claim 10 wherein the configurator and executor are on the same local computer system.

19. The system as defined by claim 10 further comprising a plurality of display screen templates substantially each having the screen format of the legacy insurance archiving system, the plurality of display screen templates having fields that each are configured to display at least one datum of the received insurance data.

20. A computer program product for use on a computer system for retrieving and presenting insurance data from a legacy insurance data archiving system, the computer program product comprising a tangible, non-transient computer usable medium having computer readable program code thereon, the computer readable program code comprising:
program code for receiving insurance data that originated from legacy data storage of the legacy insurance data archiving system, the legacy insurance archiving system having an associated legacy format for formatting the insurance data for display on a display device, the legacy format including at least a screen format for displaying the insurance data on the display device;
program code for storing the received insurance data in a database on memory of a second insurance data archiving system for subsequent retrieval;
program code for forming a display screen template substantially having the screen format of the legacy insurance archiving system, the display screen template having a plurality of fields that each are configured to display at least one datum of the received insurance data;
program code for storing the display screen template in the memory of the second insurance data archiving system for subsequent retrieval;
program code for receiving a request from a requestor to access at least one datum of the received insurance data;
program code for retrieving, in response to receipt of the request, the stored display screen template;
program code for accessing the database, with a processor, to retrieve the at least one datum based on the fields of the display screen template to produce at least one retrieved datum;
program code for populating the fields of the retrieved display screen template with the at least one retrieved datum to produce a populated display screen template having the screen format of the legacy insurance archiving system; and
program code for forwarding the populated display screen template for display on a display device.

21. The computer program product as defined by claim 20 further comprising:
program code for transforming the received insurance data into a second system format to produce transformed insurance data, the transformed insurance data being compatible with the second system and the display screen template; and
program code for storing the transformed insurance data in the database.

22. The computer program product as defined by claim 21 wherein the program code for transforming comprises program code for transforming the received insurance data into ASCII format.

23. The computer program product as defined by claim 20 further comprising:
program code for displaying a user interface having a request field for requesting insurance data from the second system;
program code for receiving information entered into the request field;
program code for accessing the database to retrieve by accessing an index of the stored insurance data based on the information in the request field; and
program code for displaying, on a display device, the insurance data by using the populated display screen template.

24. The computer program product as defined by claim 23 wherein a browser displays the user interface.

25. The computer program product as defined by claim 20 wherein the screen format of the legacy insurance archiving system includes a 24×80 format.
